(19) United States
(12) Patent Application Publication
(10) Pub. No.: US 2024/0039876 A1
(43) Pub. Date: Feb. 1, 2024

(54) INTERACTIVE MESSAGING SYSTEM AND THE METHOD

(71) Applicant: Juehu Yan, Quanzhou (CN)

(72) Inventor: Juehu Yan, Quanzhou (CN)

(21) Appl. No.: 18/378,639

(22) Filed: Oct. 10, 2023

(30) Foreign Application Priority Data
May 19, 2023 (CN) 202310569254.4

(51) Int. Cl. H04L 51/08; H04L 51/52

(52) U.S. Cl. CPC H04L 51/08; H04L 51/52

(57) ABSTRACT

An interactive messaging system including a display interface, a raw data layer, an interactive messaging data layer and an interactive replying data layer is provided. The raw data layer is configured to display a raw posting data and a message instructions frame on the display interface. The message instructions frame is configured to link to the interactive messaging data layer. The interactive messaging data layer is superimposed displaying on the raw data layer, and configured to displaying a message data loading window and a reply instructions frame on the display interface. The interactive replying data layer is superimposed displaying on the interactive messaging data layer, and configured to displaying a reply data loading window on the display interface.

### CROSS REFERENCE TO RELATED APPLICATION

This patent application claims the benefit and priority of Chinese Patent Application No. 2023105692544 filed on May 19, 2023, the disclosure of which is incorporated by reference herein in its entirety as part of the present application.

### TECHNICAL FIELD

The present disclosure relates to the field of intelligent interactive technology, and in particular relates to a system and method for revising-reading interactive message.

### BACKGROUND ART

With the popularization of computer and internet technology, the way of posting message on smart platforms or network platforms tends to be more and more diversified. The feedbacking mode of the existing interactive message is to open up a new area under the current posting message, which is used for displaying the message and carrying out the interaction between multiple users. It is very unfriendly for someone need to directly interacting in the position of the posting information. That can not realize the corresponding information interactions in any position of the posting information.

For example, the current classroom teaching is no longer confined to traditional paper-based teaching. Many schools have begun to introduce computers or the internet for teaching in the daily curriculum. However, at present, in teaching, the teacher can only use the computer to complete some simple smart operation during the question pushing. The content of the student's answer can not fill in the answer on the designated position as on the traditional exam paper. So based on the current smart messaging can not intuitively show the answer of different students in the title of the answer blanks. That makes it difficult for teachers to review and approval the exam based on the smart/network platforms, and it is not conducive to smart teaching.

In the designing of the network page interaction, the traditional message mode is also displaying the message content on the bottom of the posting information according with the order of the user's message. It is relatively independent between the message content displaying position and the posting information displaying position. For the need to reply to the or more specific contents in the posting information, the interactive operation experience is poor for network users to post or browse the message.

Therefore, it is an urgent technical problem to be solved by a person of ordinary skill in the art to provide a system and method of interactive message that can enhance the user interaction experience.

### SUMMARY

The present disclosure provides a system and method for interactive messaging to solve the above-mentioned prior art problems.

The present disclosure provides an interactive messaging system firstly which includes: a display interface, a raw data layer, an interactive messaging data layer and an interactive replying data layer.

The raw data layer is configured to display a raw posting data and a message instructions frame on the display interface. The message instructions frame is configured to link to the interactive messaging data layer, or to link to the interactive messaging data layer and the interactive replying data layer synchronously.

The interactive messaging data layer is superimposed displaying on the raw data layer, and configured to displaying a message data loading window and a reply instructions frame on the display interface. The message data loading window is disposed on a superimposition position corresponding to the display interface of the raw posting data, and receives an input messaging data on the superimposition position, and/or, displays the input messaging data on the superimposition position. The reply instructions frame is configured to link to the interactive replying data layer.

The interactive replying data layer is superimposed displaying on the interactive messaging data layer, and configured to displaying a reply data loading window on the display interface. The reply data loading window is disposed on a superimposition position corresponding to the display interface of the message data, and receives an input replying data at the superimposition position, and/or, displays the input replying data.

Preferably, the raw posting data includes: a combination of the or more of the following: text data, pdf files, word documents, image data, video data, hypertext data, and web page data.

Preferably, the message instructions frame includes a plurality of sub message instructions frames. And each of the sub message instruction frames, after receiving a trigger instruction, links to the interactive messaging data layer of a particular user.

Preferably, after the message instructions frame receiving the triggering instructions, the plurality of the sub message instructions frames are arranged to be displayed on the display interface in accordance with a specified rule.

Preferably, the message instructions frame includes a sub message adding instructions frame for adding a new sub message instructions frame after receiving the trigger instruction.

Preferably, the superimposition position corresponding to the interactive messaging data layer includes: a position vectorially corresponding with a position of the display interface of the raw posting data, or an arbitrary position corresponding with a position of the display interface of the raw posting data.

Preferably, the interactive messaging data layer is further configured to display a messaging completion instructions frame on the display interface. The messaging completion instructions frame is configured to submit and post the message data to a backend storing the content and a location information of the message data.

Preferably, the superimposition position corresponding to the interactive replying data layer includes: a position vectorially corresponding with a position of the display interface of the message data, or an arbitrary position corresponding with a position of the display interface of the message data.

Preferably, the interactive replying data layer is further configured to display a replying completion instructions frame on the display interface. The replying completion instructions frame is configured to submit and post a reply data to a backend storing the content and a location information of the reply data.

Preferably, the message data and the reply data both include: a combination of the or more of the following: handwritten data, arbitrary curve data, text data, and voice data.

The present disclosure provides an interactive messaging method of the interactive messaging system secondly which includes: responding to a display interface loading instruction from a user; loading and displaying the display interface and the raw data layer of the display interface; loading and displaying the interactive messaging data layer, comprising receiving the message data entered by the user at the superimposition location of the interactive messaging data layer, and/or, displaying the message data entered by the user; loading and displaying the interactive replying data layer, comprising receiving the replying data entered by the user at the superimposition location of the interactive replying data layer, and/or, displaying the replying data entered by the user.

Preferably, the present disclosure further includes steps as following: reading identity attribute of a first user, confirming whether the first user has an interactive messaging permission based on the identity attribute, or granting the first user an interactive messaging permission based on the identity attribute.

The interactive messaging permission includes a combination of the or more of the following: a messaging newly permission which is a permission for entering the message data in the superimposition position of the interactive messaging data layer, a replying message permission which is a permission for entering the replying data in the superimposition position of the interactive replying data layer, a viewing message permission which is a permission for displaying a message data of a second user on the superimposition position of the interactive messaging data layer, or permission for displaying corresponding reply data of the message data of the second user on superimposition position of the interactive messaging data layer while the permission for displaying the message data of the second user on the superimposition position of the interactive messaging data layer. The second user includes the first user and/or users except the first user.

The present disclosure has many beneficial effects over the prior art.

The present disclosure can realize arbitrary interactive messaging in the display interface. The fusion display effect of the message content, reply content and the raw posting data is improved. The ability of the users to create and view new message for specific content in the raw posting data, as well as to create and view the new reply for specific content in the message data is enhanced.

The present disclosure innovatively proposes a revising-reading interactive messaging method which simulates the interaction of students answering questions at specific position in the exam paper and the teacher reviewing at the answering position of the students. The experience of the users of the smart teaching and network interaction page is improved.

### BRIEF DESCRIPTION OF THE DRAWINGS

In order to illustrate embodiments of the present disclosure or technical solutions in the prior art more clearly, a brief introduction will be made to attached drawings needed to be used in the description of the embodiments or the prior art in the following. Obviously, the attached drawings in the following description are only some embodiments of the present disclosure, and for those of ordinary skill in the art, other attached drawings may be obtained according to these attached drawings without inventive efforts.

FIG. 1 is a block diagram of an interactive messaging system provided by the embodiment of the disclosure;

FIG. 2 is a flowchart of a method for an interactive messaging provided by the embodiment of the disclosure;

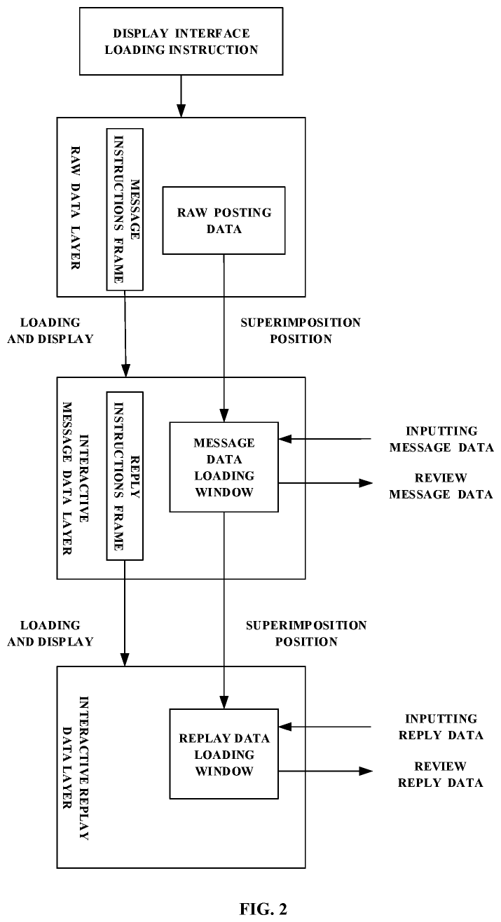

FIG. 3 is a schematic diagram of a display interface provided by the embodiment of the disclosure;

FIG. 4 is a schematic diagram of the display interface loading a raw data layer provided by the embodiment of the disclosure;

FIG. 5 is an expanded schematic diagram of a message instructions frame in the interactive messaging data layer provided by the first embodiment of the disclosure;

FIG. 6 is a schematic diagram of the interactive messaging data layer of the display interface after loading a message from user A provided by the first embodiment of the disclosure;

FIG. 7 is a schematic diagram of an interactive replying data layer of a display interface for loading reply data of user C to a message of user A provided by the first embodiment of the disclosure;

FIG. 8 is a schematic diagram of the interactive messaging data layer of the display interface after loading a message from User B provided by the first embodiment of the disclosure;

FIG. 9 is a schematic diagram of an interactive replying data layer of the display interface for loading reply data of user C to a message of user B provided by the first embodiment of the disclosure;

FIG. 10 is a schematic diagram of a raw posting data provided by the first embodiment of the disclosure;

FIG. 11 is a schematic diagram of a message data loading window provided by the first embodiment of the disclosure;

FIG. 12 is a schematic diagram of a reply data loading window provided by the first embodiment of the disclosure.

### DETAILED DESCRIPTION OF THE EMBODIMENTS

In connection with the accompanying drawings according to embodiments of the present disclosure, technical solutions in the embodiments of the present disclosure are described. Apparently, the embodiments thus described are merely a part of the embodiments of the present disclosure and do not constitute the embodiments in their entirety. According to the embodiments of the present disclosure, all other embodiments obtained by a person of ordinary skill in the art without creative efforts are within the scope of the protection of the present disclosure.

The application principle of the disclosure is described in detail in conjunction with the accompanying drawings.

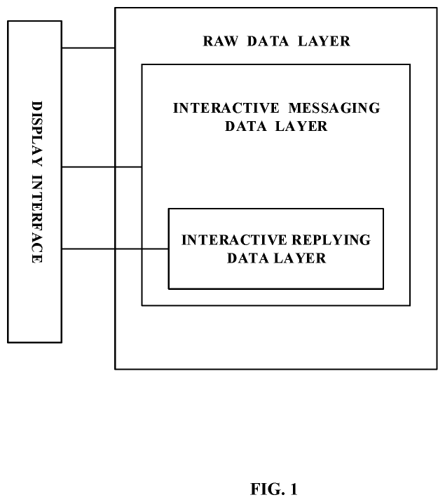

As shown in FIG. 1, The present disclosure provides an interactive messaging system firstly which includes: a display interface, a raw data layer, an interactive messaging data layer and an interactive replying data layer.

The raw data layer is configured to display a raw posting data and a message instructions frame on the display interface. The message instructions frame is configured to link to the interactive messaging data layer, or to link to the interactive messaging data layer and the interactive replying data layer synchronously.

The interactive messaging data layer is superimposed displaying on the raw data layer, and configured to displaying a message data loading window and a reply instructions frame on the display interface. The message data loading window is disposed on a superimposition position corresponding to the display interface of the raw posting data, and receives an input messaging data on the superimposition position, and/or, displays the input messaging data on the superimposition position. The reply instructions frame is configured to link to the interactive replying data layer.

The interactive replying data layer is superimposed displaying on the interactive messaging data layer, and configured to displaying a reply data loading window on the display interface. The reply data loading window is disposed on a superimposition position corresponding to the display interface of the message data, and receives an input replying data at the superimposition position, and/or, displays the input replying data.

According to the embodiment, after loading the raw posting data to be displayed in the display interface, the system simultaneously loads an additional interactive messaging data layer corresponding to the corresponding position of the raw data layer to leave a message and an interactive replying data layer corresponding to the corresponding position of the interactive messaging data layer to make a reply. The message layer data, the interactive replying data layer and the raw data layer are independent of each other, do not interfere with each other, and are displayed in superposition together.

According to the embodiment, the raw posting data includes: a combination of the or more of the following: text data, pdf files, word documents, image data, video data, hypertext data, and web page data. Various data format displaying interface windows can be implemented in the embodiment, and an additional interactive message data layer is disposed to realize the interaction of messages.

According to the embodiment, the message data and the reply data both include: a combination of the or more of the following: handwritten data, arbitrary curve data, text data, and voice data.

According to the first embodiment, an interactive messaging system in a smart teaching environment is described below.

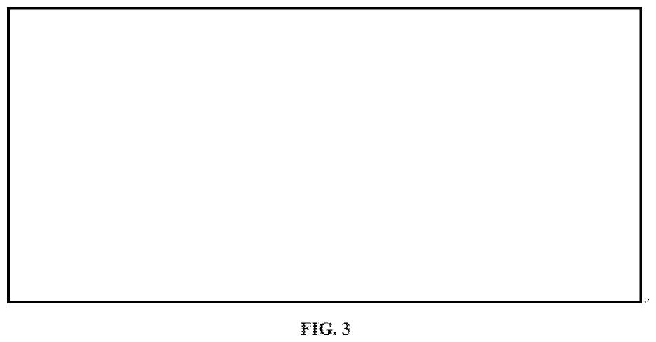

As shown in FIG. 3, the display interface is provided to be displayed on a display terminal with arbitrarily form, including window form, page form, and the like.

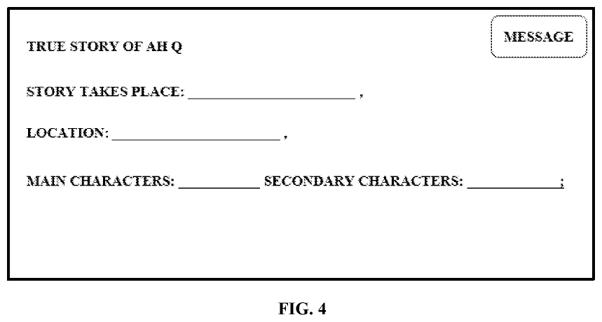

As shown in FIG. 4, it is the display interface after loading the raw data layer. The display interface displays the message data loading window. The raw posting data is in the message data loading window. The message instructions frame is displayed at the side of the message data loading window. It should be noted that the exact position of the message instructions frame displayed is not limited in the display interface. The middle segment of the raw posting data is set with a vacant position for a pending message, which is the position requiring for other users to leave a message or reply. The superimposition position of the interactive messaging data layer may be the vacant position. When a user needs to leave a message in response to the current raw posting

data, they can link to the interactive messaging data layer by clicking on the message instructions frame.

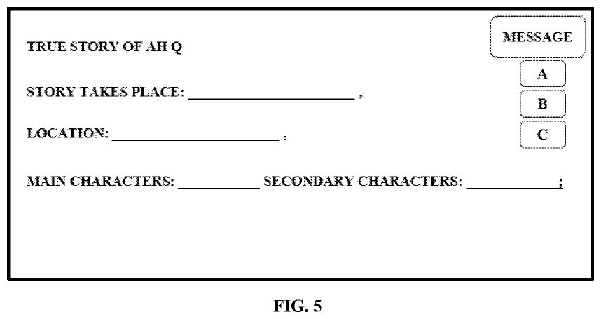

According to the embodiment, as shown in FIG. 5, the message instructions frame includes a number of sub message instructions frame, and the sub message instructions frame are configured to link to the interactive messaging data layer of a unique user after receiving a trigger instruction. When needed to fill out and post a message, a user-A can click on the first sub message instructions frame and fill out the message in the superimposition position of the interactive messaging data layer corresponding to the vacant position of the raw posting data.

According to the embodiment, as shown in FIG. 5, the message instructions frame includes a sub message adding instructions frame for adding a new sub message instructions frame after receiving a trigger instruction. For example, a sub message adding instructions frame with a sign “+” is set below the sub message instructions frame of a user (user-A, user-B) who has already left a message.

According to the embodiment, as shown in FIG. 5, when the user-C needs to view's the messages of all users under the current raw posting data, the sub message instructions frame can be expanded to display the sub message instructions frame of all users who have left messages by clicking on the sub message adding instructions frame. Moreover, after the message instructions frame receiving the triggering instructions, the plurality of the sub message instructions frames are arranged to be displayed on the display interface in accordance with a specified rule.

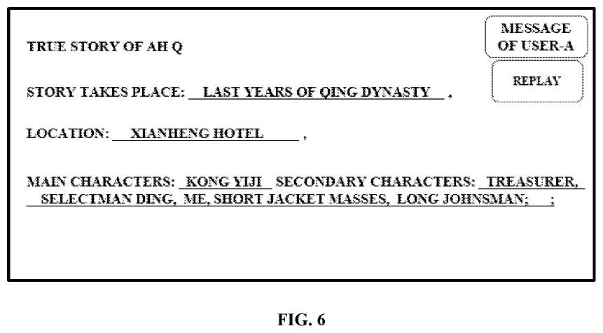

The display rule of the interactive messaging data layer includes: when the raw data layer is loaded only, the message data loading window and the reply instructions frame will not be displayed on the display interface. The message of the user is viewed by clicking and triggering the message instructions frame, and further clicking and triggering the sub message instructions frame of the user (the display form can be the avatar of the user who has left the message), as shown in FIG. 6. If there is an interactive message between two users, the message will be displayed together, including a reply data of publishers to the current user message data of the raw posting data, as well as reply data of other users.

According to the embodiment, the superimposition position corresponding to the interactive messaging data layer includes: a position vectorially corresponding with a position of the display interface of the raw posting data, or an arbitrary position corresponding with a position of the display interface of the raw posting data.

According to the embodiment, the corresponding superimposition position of the interactive messaging data layer includes: a position corresponding timeline to the raw posting data with the timeline information. The raw posting data with the timeline information includes the video data, and the message data is loaded and displayed at a specified time node of the timeline, which is corresponding to the superimposition position.

In specific execution, for the case where the raw posting data is video data, the message data loading window is disposed on the video data of the corresponding time node and receives the inputting message data at the time node. The corresponding time node is the current playback timeline position of the display interface where the video data is disposed on the time while releasing the message. The input message data is displayed synchronously when the video data is played to the time node.

Clicking and triggering the message instructions frame of the user who has posted message data on the raw data layer, the timeline fast-forwards to the playback position of the time node, the message data loading window of a user is displayed in synchronization with the raw posting data, and the vectoral position of the message data loading window is displayed superimposed on the vectoral position of the raw data layer.

According to the embodiment, the interactive messaging data layer is further configured to display a messaging completion instructions frame on the display interface. The messaging completion instructions frame is configured to submit and post the message data to a backend storing the content and a location information of the message data.

According to the present embodiment, the message data may be saved in the attachment file or stored and loaded as a new file data with the raw posting data.

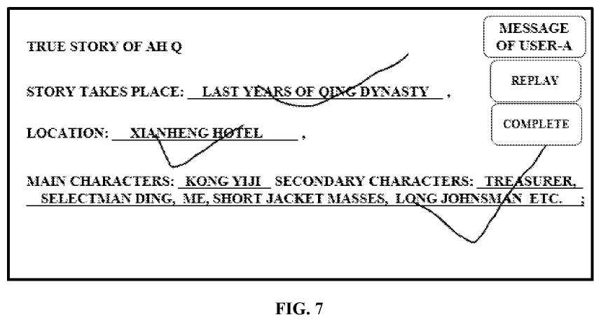

According to the embodiment, as shown in FIG. 7, when needs to reply the message data posted by user-A, user-C firstly clicks and triggers on the message instructions frame of the raw data layer to display the message data loading window and the reply instructions frame of user-A. After reading the message data of user-A, it will link to the interactive replying data layer for inputting the reply data by clicking and triggering on the reply instructions frame after the message data of user-A on the interactive messaging data layer.

When needs to view the reply data of the message data posted by user-A, user-C firstly clicks and triggers the message instructions frame on the raw data layer to display the message data loading window and the reply instructions frame of user-A. By further clicking and triggering the reply instructions frame after the message data of user-A on the interactive messaging data layer, it will link to the interactive replying data layer for viewing the reply data. Or, while displaying the message data loading window and the reply instructions frame of user-A, the reply data loading window in the interactive replying data layer linked to the reply instructions frame that displays the message data of user-A is loaded automatically, thereby displaying the reply data of user-A entered under the message data.

According to the embodiment, the message instructions frame is associated with a reply instructions frame, link and display the reply instructions frame by clicking and triggering on the message instructions frame. Or, each sub message instructions frame is associated with a reply instructions frame, links and displays the current reply instructions frame of a user by clicking and triggering the corresponding sub message instructions frame the user. It should be noted that the exact location of the reply instructions frame displayed in the display interface is not limited.

According to the embodiment, the superimposition position corresponding to the interactive replying data layer includes: a position vectorially corresponding with a position of the display interface of the message data, or an arbitrary position corresponding with a position of the display interface of the message data.

According to the embodiment, the corresponding superimposition position of the interactive replying data layer includes: a position corresponding timeline to the raw posting data containing the timeline information, or a position corresponding timeline to the message data containing the timeline information. The raw posting data with the timeline information includes the video data, and the reply data is loaded and displayed at a specified time node of the timeline, which is corresponding to the superimposition position.

In specific execution, for the case where the raw posting data is video data, the reply data loading window is disposed on the video data of the corresponding time node and receives the inputting reply data at the time node. The corresponding time node is the current playback timeline position of the display interface where the video data is disposed on the time while releasing the reply. The input message data is displayed synchronously when the video data is played to the time node.

Clicking and triggering the message instructions frame of the user who has posted reply data on the raw data layer, the timeline fast-forwards to the playback position of the time node, the reply data loading window of a user is displayed in synchronization with the raw posting data, and the vectoral position of the reply data loading window is displayed superimposed on the vectoral position of the raw data layer, or displayed in superimposition with the vectoral position of the interactive messaging data layer.

According to the embodiment, the interactive replying data layer is further configured to display a replying completion instructions frame on the display interface. The replying completion instructions frame is configured to submit and post a reply data to a backend storing the content and a location information of the reply data.

As shown in FIG. 7, in the display interface after user-C replied to the message of user-A, user-C clicks and triggers the reply instructions frame and then makes an instruction to put three checkmarks on the corresponding superimposition position of the message data posted by user-A as the reply data for replying to message data of user-A; and clicks and trigger the reply completion instructions frame to complete the reply.

According to the embodiment, the interactive replying data layer is also used to display a new reply instructions frame associated with the current reply instructions frame on the display interface for entering and loading the new reply data displayed in the current interactive replying data layer.

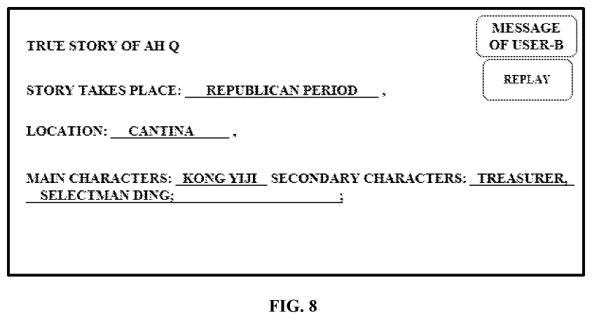

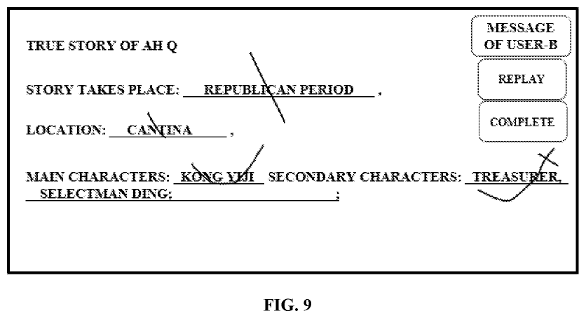

As shown in FIGS. 8-9, it is respectively the display interface after user-B leaving a message and the display interface after user-C replying to the message of user-B. The difference with the embodiment shown in FIG. 7 is that for different message data contents, user-C makes a different review to the reply data. It is more intuition and convenience for a user to operating in the process of leaving the message and reviewing the reply.

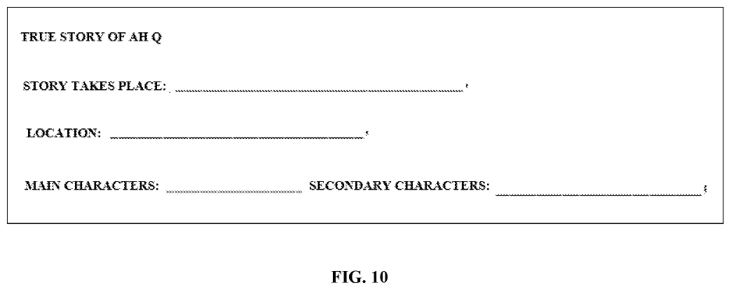

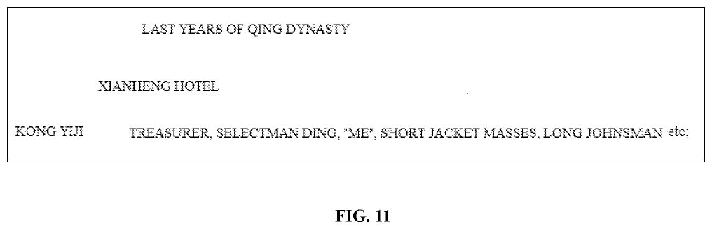

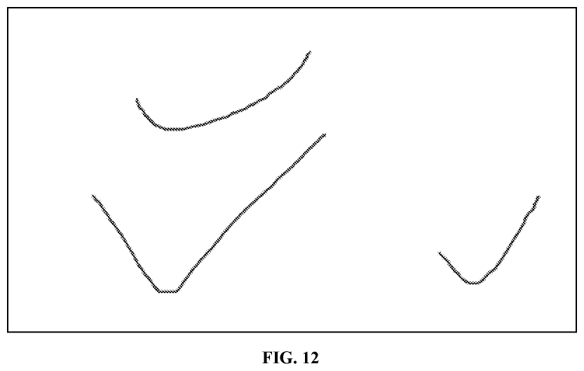

According to the first embodiment in FIGS. 10-12, it is shown the raw posting data in the raw data layer, the message data loading window in the interactive messaging data layer, and the data display contents of the reply data loading window in the interactive replying data layer respectively.

The present disclosure provides an interactive messaging method of the interactive messaging system secondly.

The method includes: responding to a display interface loading instruction from a user; loading and displaying the display interface and the raw data layer of the display interface; loading and displaying the interactive messaging data layer, comprising receiving the message data entered by the user at the superimposition location of the interactive messaging data layer, and/or, displaying the message data entered by the user; loading and displaying the interactive replying data layer, comprising receiving the replying data entered by the user at the superimposition location of the interactive replying data layer, and/or, displaying the replying data entered by the user.

The specific embodiment of the interactive messaging method provided secondly is the same in the execution steps involved in the specific execution as the specific embodiment provided firstly of the disclosure.

According to the embodiment, it further includes a permission authentication step in the process of executing the interactive messaging method, so that only the users with corresponding permissions can execute the corresponding interactive messaging operation.

The method specifically includes steps as following: reading identity attribute of a first user, confirming whether the first user has an interactive messaging permission based on the identity attribute, or granting the first user an interactive messaging permission based on the identity attribute.

The interactive messaging permission includes a combination of the or more of the following: a messaging newly permission which is a permission for entering the message data in the superimposition position of the interactive messaging data layer, a replying message permission which is a permission for entering the replying data in the superimposition position of the interactive replying data layer, a viewing message permission which is a permission for displaying a message data of a second user on the superimposition position of the interactive messaging data layer, or permission for displaying corresponding reply data of the message data of the second user on superimposition position of the interactive messaging data layer while the permission for displaying the message data of the second user on the superimposition position of the interactive messaging data layer. The second user includes the first user and/or users except the first user.

In the application scenario of the first embodiment of the present disclosure, the needs of new smart teaching base on learning with the display terminal (tablet) plus stylus can be satisfied. For example, the teacher arranges a topic, requiring students to complete the answer, the students can start answering using a handwriting stylus, or other directly writing ways just by clicking on the message. After finishing the answering, it can be finished by clicking on the message. The teacher can set up a message permission, non-teammate can not leave a message. A user will be allowable to view the other messages only after leaving a message. So as to ensure that every teammate need to complete the answer, each one can also view the messages of other one after completing the answer. It is greatly improving the efficiency. The teacher can revise the answer of students just by clicking and viewing the corresponding messages of the student. Someone with doubts can be replied again after the students read the reply message of the teacher.

The interactive messaging system and method of the present disclosure are not limited to the application scenarios provided in the first embodiment. It may be applicable to any kind of interactive messaging scenario with a display interface. According to the second embodiment, the interactive messaging system in a web page environment is illustrated.

A user posts a post on the display interface of the network platform. The content of the post can be the words that needs to fill in the blanks, or fill in the number of charts, or drawings of the drawing board, etc. Other users can directly leave comments and replies on the corresponding interactive position to fill in the blanks, fill in the number of charts, or drawings after seeing the post on the network platform of the post, rather than to go to the bottom of all the posts to complete the messaging and replying. When viewing and reviewing messages and replies, there is no need to repeatedly compare the raw posting message and the content of reply data, and no need to copy the complete text content, chart formatting and drawing templates when leaving a message. The interactive experience is greatly improved.

The above-mentioned disclosure provides a detailed introduction of the interactive messaging system and method. Detail description has been provided to the method and apparatus mentioned above according to embodiments of the present disclosure. Specific examples are set forth herein to illustrate the principles and embodiments of the present disclosure. The above description is for the purpose of helping understand the inventive method and its core idea. At the same time, it is understood by those of ordinary skill in the art that, in accordance with the concepts of the present disclosure, alterations may be provided to the embodiments and scope of implementation thereof. Altogether, the description is not to be construed as a limitation on the present disclosure.

It should be noted that relational terms used herein, such as first and second, and the like, are used to distinguish the entity or operation from another entity or operation, without necessarily requiring or implying the actual existence of any such relationship or order between these entities or operations. Terms “including” “comprising” or any other variations thereof, are intended to cover a non-exclusive inclusion, such that a process, method, article, or apparatus that includes a series of elements not only includes those elements but also includes other elements not expressly listed, or those elements inherent to such process, method, article, or apparatus. In the absence of any other constraints, an element defined by the term “includes the . . . ” does not exclude other same elements included in the process, method, article, or apparatus that includes the element.

What is claimed is:

1. An interactive messaging system, comprising: a display interface, a raw data layer, an interactive messaging data layer and an interactive replying data layer;
wherein the raw data layer is configured to display a raw posting data and a message instructions frame on the display interface, the message instructions frame is configured to link to the interactive messaging data layer, or to link to the interactive messaging data layer and the interactive replying data layer synchronously;
the interactive messaging data layer is superimposed displaying on the raw data layer, and configured to displaying a message data loading window and a reply instructions frame on the display interface, the message data loading window is disposed on a superimposition position corresponding to the display interface of the raw posting data, and receives an input messaging data on the superimposition position, and/or, displays the input messaging data on the superimposition position, the reply instructions frame is configured to link to the interactive replying data layer;
the interactive replying data layer is superimposed displaying on the interactive messaging data layer, and configured to displaying a reply data loading window on the display interface, the reply data loading window is disposed on a superimposition position corresponding to the display interface of the message data, and receives an input replying data at the superimposition position, and/or, displays the input replying data.

2. The interactive messaging system of claim 1, wherein the message instructions frame includes a plurality of sub message instructions frames, and each of the sub message instruction frames, after receiving a trigger instruction, links to the interactive messaging data layer of a particular user.

3. The interactive messaging system of claim 2, wherein, after the message instructions frame receiving the triggering instructions, the plurality of the sub message instructions frames are arranged to be displayed on the display interface in accordance with a specified rule.

4. The interactive messaging system of claim 2, wherein the message instructions frame includes a sub message adding instructions frame for adding a new sub message instructions frame after receiving the trigger instruction.

5. The interactive messaging system of claim 1, wherein the superimposition position corresponding to the interactive messaging data layer includes: a position vectorially corresponding with a position of the display interface of the raw posting data, or an arbitrary position corresponding with a position of the display interface of the raw posting data.

6. The interactive messaging system of claim 1, wherein the interactive messaging data layer is further configured to display a messaging completion instructions frame on the display interface, the messaging completion instructions frame is configured to submit and post the message data to a backend storing the content and a location information of the message data.

7. The interactive messaging system of to claim 1, wherein the superimposition position corresponding to the interactive replying data layer includes: a position vectorially corresponding with a position of the display interface of the message data, or an arbitrary position corresponding with a position of the display interface of the message data.

8. The interactive messaging system of claim 1, wherein the interactive replying data layer is further configured to display a replying completion instructions frame on the display interface, the replying completion instructions frame is configured to submit and post a reply data to a backend storing the content and a location information of the reply data.

9. An interactive messaging method of the interactive messaging system according to claim 1, comprising: responding to a display interface loading instruction from a user; loading and displaying the display interface and the raw data layer of the display interface; loading and displaying the interactive messaging data layer, comprising receiving the message data entered by the user at the superimposition location of the interactive messaging data layer, and/or, displaying the message data entered by the user; loading and displaying the interactive replying data layer, comprising receiving the replying data entered by the user at the superimposition location of the interactive replying data layer, and/or, displaying the replying data entered by the user.

10. The interactive messaging method of claim 9, further comprising: reading identity attribute of a first user, confirming whether the first user has an interactive messaging permission based on the identity attribute, or granting the first user an interactive messaging permission based on the identity attribute; wherein the interactive messaging permission includes a combination of the or more of the following:
a messaging newly permission: permission for entering the message data in the superimposition position of the interactive messaging data layer;
a replying message permission: permission for entering the replying data in the superimposition position of the interactive replying data layer;
a viewing message permission: permission for displaying a message data of a second user on the superimposition position of the interactive messaging data layer, or permission for displaying corresponding reply data of the message data of the second user on superimposition position of the interactive messaging data layer while the permission for displaying the message data of the second user on the superimposition position of the interactive messaging data layer;
the second user comprising the first user and/or users except the first user.
